(19) United States
(12) Patent Application Publication
(10) Pub. No.: US 2022/0105457 A1
(43) Pub. Date: Apr. 7, 2022

(54) AIR PURIFICATION SYSTEM

(71) Applicant: Timilon Corporation, Bonita Springs, FL (US)

(72) Inventors: Kyle Knappenberger, Topeka, KS (US); Brandon Walker, Sabetha, KS (US); George Negron, Cape Coral, FL (US); Bill R. Sanford, Naples, FL (US)

(21) Appl. No.: 17/491,665

(22) Filed: Oct. 1, 2021

Related U.S. Application Data
(60) Provisional application No. 63/086,437, filed on Oct. 1, 2020.

(51) Int. Cl. B01D 46/10; F24F 8/108; B01D 46/00; B01D 39/20

(52) U.S. Cl. CPC B01D 46/10; F24F 8/108; B01D 2279/65; B01D 39/2027; B01D 2259/804; B01D 46/0005

(57) ABSTRACT

Air purification apparatus is provided that removes undesirable substances, such as particulate materials, malodors, viruses, bacteria, fungi, and toxins, from the air present within an enclosed environment. The apparatus is switchable between a mode in which air immediately adjacent the apparatus housing is drawn in and purified, and a mode in which air remote from the apparatus housing is drawn in from a specific point within the enclosed environment through use of an elongate duct.

### CROSS-REFERENCE TO RELATED APPLICATION

This application claims the benefit of U.S. Provisional Patent Application No. 63/086,437, filed Oct. 1, 2020, which is incorporated by reference herein in its entirety.

### BACKGROUND OF THE INVENTION

### Field of the Invention

The present invention generally pertains to air purification apparatus that removes undesirable substances, such as particulate materials, malodors, viruses, bacteria, fungi, and toxins, from the air present within an enclosed environment. The apparatus has the capability to draw in and process air from the enclosed environment generally as well as to draw in air from a specific localized space within the enclosed environment.

### Description of the Prior Art

Aerosols comprising pathogenic and/or toxic materials can be generated by many kinds of processes. Certain medical and dental procedures are well known for generating aerosols that may contain harmful pathogens. In the particular context of dental procedures, the combination of compressed air and water can result in the generation of aerosols from the patient's oral cavity that contain bacteria and viruses. These bacteria and viruses, once liberated from the patient's body, can linger in the procedure room for hours or days and create hazards for office staff and other patients.

Extraoral dental suction systems have been proposed to capture these aerosols and remove the dangerous contaminants. In particular, these devices are bulky and occupy quite a bit of space in an operatory that is already filled with equipment. Many of these systems also do not have the functionality of being a “whole room” air purification system. Thus, when not being used during a procedure, these systems are switched off and do not provide ongoing air purification within the operatory. In order to address this, a second whole-room air purifier is required in addition to the extraoral suction system. This solution only exacerbates the problem of limited space within a standard dental operatory.

Similar problems exist in other medical environments, such as operating rooms, veterinary clinics, and other point-of-care facilities. Outside of the medical field, other industries could also benefit from point-source and whole-room air purification systems, including laboratory and manufacturing settings in which toxic materials are being handled.

Thus, a need exists in the art for an integrated solution to whole-room and point-of-procedure air purification in which both demands are addressed by a single device.

### SUMMARY OF THE INVENTION

According to one embodiment of the present invention there is provided air purifying apparatus comprising a housing, a blower and filter media contained within the housing. The housing comprises at least first and second air inlets and at least one air outlet. The blower is operable to induce a flow of air within the housing. The flow of air is selectively directed along either a first flow path located between the first air inlet and the at least one air outlet or a second flow path located between the second air inlet and the at least one air outlet. The filter media is contained within the housing and positioned across the flow paths, such that the flow of air within the housing passes through the filter media. The filter media comprises an adsorbent, absorbent, and/or neutralizing material capable of removing one or more undesirable substances from the flow of air.

According to another embodiment of the present invention there is provided air purifying apparatus comprising a housing having first and second air inlets and at least one air outlet, a blower operable to induce a flow of air within the housing, an air diverter assembly, and filter media. The first air inlet is configured to generally draw air into the housing from an enclosed space in which the apparatus is located. The second air inlet is coupled with an elongate duct having a duct inlet and a duct outlet. The duct inlet is configured to be selectively positioned adjacent a localized region within the enclosed space and draw air into the duct from the localized region. The duct outlet is connected to the second air inlet. The blower is operable to induce a flow of air within the housing between either a first flow path located between the first air inlet and the at least one air outlet or a second flow path located between the second air inlet and the at least one air outlet. The air flow diverter assembly is configured to be switchable between a first configuration in which the first flow path is blocked and the second flow path is opened, and a second configuration in which the second flow path is blocked and the first flow path is opened. The filter media is contained within the housing and positioned between the first and second air inlets and the at least one air outlet such that air flowing through either the first or second flow path passes through the filter media. The filter media comprises a first filter section that includes metal oxide or metal hydroxide nanocrystalline particles capable of removing one or more undesirable substances from the flow of air, and a second filter section that includes a high efficiency particulate air (HEPA) filter.

According to still another embodiment of the present invention there is provided a method of removing contaminants from air. The method comprises inducing a flow of air within a housing of an air purification apparatus using a blower installed within the housing. The flow of air is selectively caused to enter the housing through either of a first or second air inlet and exit the housing through at least one air outlet. The flow of air, as it flows through the housing, is directed along either a first flow path located between the first air inlet and the at least one air outlet or a second flow path located between the second air inlet and the at least one air outlet. The flow of air is caused to pass through filter media contained within the housing and positioned across the first and second flow paths. The filter media comprises an adsorbent, absorbent, and/or neutralizing material capable of removing one or more undesirable substances from the flow of air.

### BRIEF DESCRIPTION OF THE DRAWINGS

FIG. 1 is a front perspective view of an air purifying apparatus in accordance with one embodiment of the present invention;

FIG. 2 is a rear perspective view of the apparatus of FIG. 1;

FIG. 3 is a front perspective view of an air purifying apparatus having an alternate elongate duct structure;

FIG. 4 is a bottom, rear perspective view of the apparatus of FIG. 3 having a rear panel removed to expose the interior of the apparatus housing;

FIG. 5 is a top, rear perspective view of the apparatus of FIG. 3 illustrating an air flow diverter assembly;

FIG. 6a is a partial cutaway view of a pleated air filter cartridge that contains nanocrystalline metal oxide or hydroxide particles that is configured for use with the air purifying apparatus;

FIG. 6b is a partial cutaway view of a honeycomb-type filter cartridge having a plurality of cells containing granulated nanocrystalline metal oxide or hydroxide particles that is configured for use with the air purifying apparatus;

FIG. 7 is a bottom, rear perspective view of the air purifying apparatus in which housing panels have been partially cut away to reveal the blower and air diverter assembly;

FIG. 8 is a sectioned view of the top of the air purifying apparatus with the air diverter assembly shown shifted to an alternate configuration;

FIG. 9 is sectioned view of the top of the air purifying apparatus taken from a bottom perspective; and

FIG. 10 is an expanded view of an alternate air filter cartridge comprising nanocrystalline particles and HEPA filter media.

While the drawings do not necessarily provide exact dimensions or tolerances for the illustrated components or structures, the drawings are to scale with respect to the relationships between the components of the structures illustrated in the drawings.

### DETAILED DESCRIPTION OF THE PREFERRED EMBODIMENT

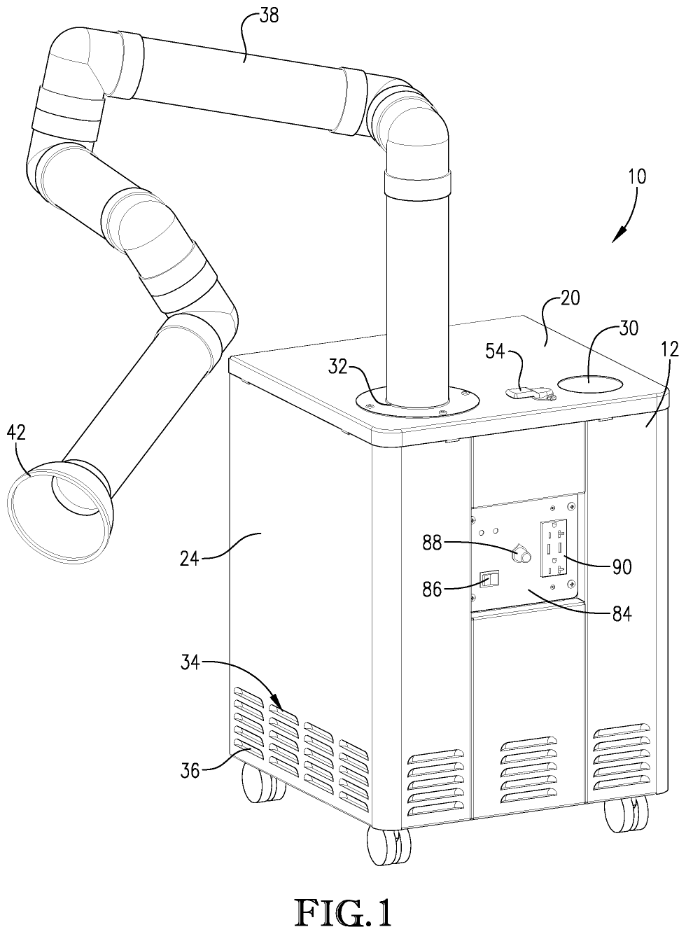

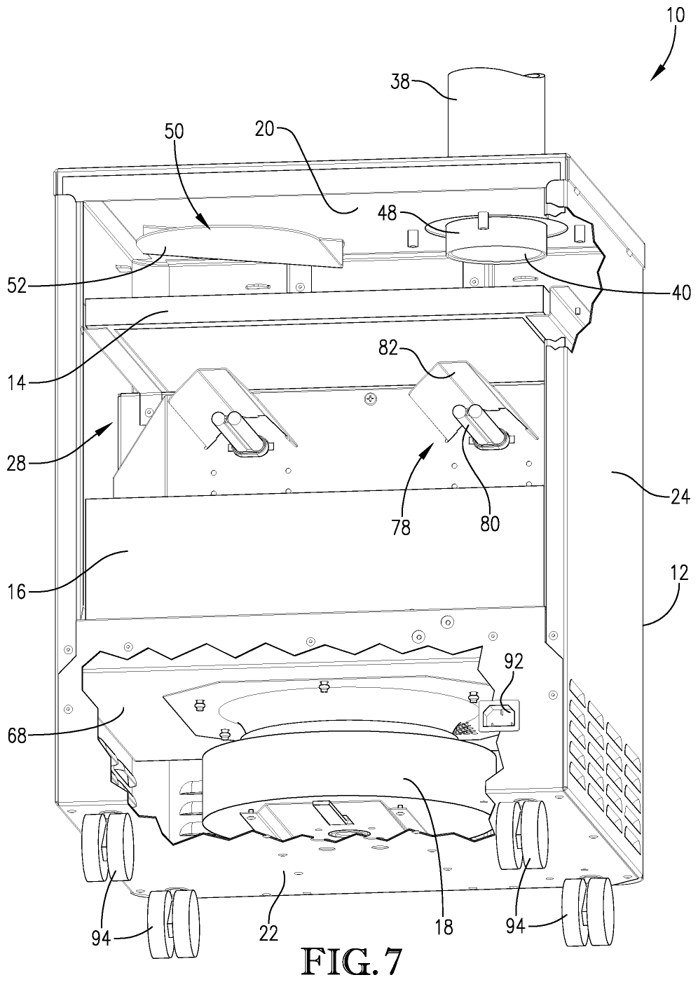

Turning to FIG. 1, an air purification apparatus 10 in accordance with an embodiment of the present invention is illustrated. Apparatus 10 generally comprises a housing 12 inside of which is contained filter media 14, 16 and a blower 18 (see, FIG. 7) that is operable to induce a flow of air within the housing.

In one or more embodiments, the housing 10 comprises a top wall 20, a bottom wall 22, and sidewall structure 24. Note, sidewall structure 24 may be comprised of a plurality of individual panels, some of which (e.g., panel 26) may be detachable to expose an interior space 28 within housing 12 within which filter media 14, 16 are located. The housing 12 comprises at least first and second air inlets 30, 32, which may be formed in top wall 20, although this need not always be the case. Note, housing 12 can be configured with a plurality of air inlets (e.g., three, four, five, or more) depending upon the application for apparatus 10. The housing 12 further comprises at least one air outlet 34. In certain embodiments, the housing comprises at least one air outlet 34 formed in each of two, three, or more panels making up the sidewall structure 24. In one or more embodiments, the at least one air outlet 34 may comprise a plurality of louvered openings 36 in the sidewall structure 24, although this need not always be the case.

The first air inlet 30 and the at least one air outlet 34 define a first flow path along which air may flow through the housing. The second air inlet 32 and the at least one air outlet 34 define a second flow path along which air may flow through the housing 12. The filter media 14, 16 is positioned within housing 12 such that it intersects the flow paths and the flow of air within the housing 12 passes through the filter media 14, 16.

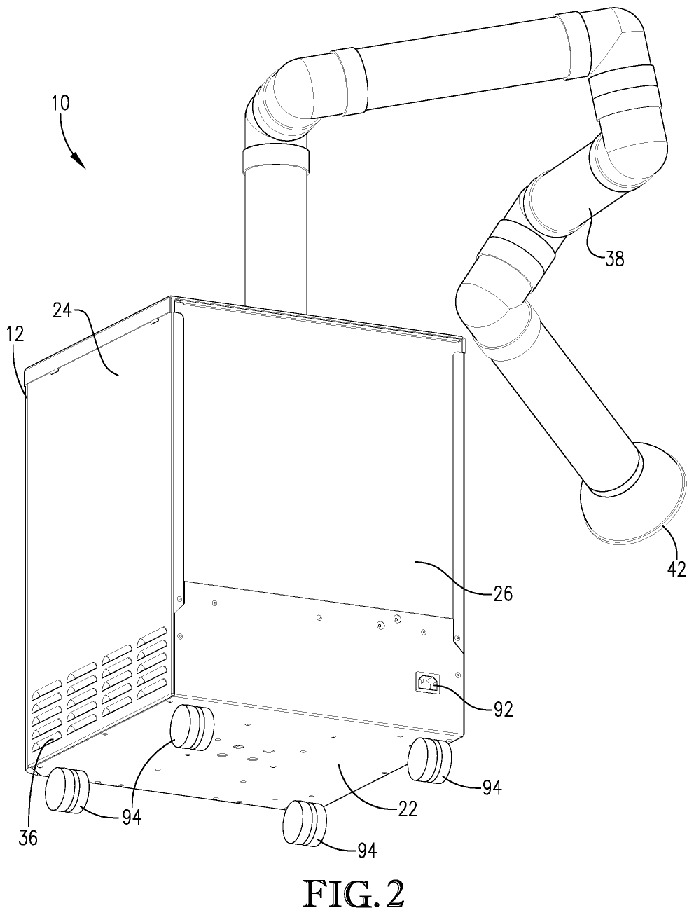

As shown in FIGS. 1 and 2 second air inlet 32 is coupled with an elongate duct 38 having a duct outlet 40 (see, FIG. 7) and a duct inlet 42. In this embodiment, duct 38 comprises a plurality of articulating segments that permit duct inlet 42 to be positioned adjacent a localized region (e.g., a specific point) away from housing 12 within an enclosed space in which apparatus 10 is located. For example, the enclosed space can be a dental operatory in which a dental procedure is occurring on a patient. During such procedures, aerosols are often generated and can spread throughout the entire operator in which a dentist, hygienist, and/or any assisting personnel are working on the patient. The articulating structure of duct 38 permits duct inlet 42 to be placed in close proximity to the patient's mouth so that any generated aerosols can be drawn into duct 38 and ultimately into the interior space 28 of housing 12 where it will pass through the filter media 14, 16. Although not illustrated, the elongate duct 38 may be provided with a separate damper or air flow control structure at or near duct inlet 42 to provide enhanced user control at the collection point.

In contrast, first air inlet 30 is configured to draw air into the housing 12 from the enclosed space in a much more general sense to provide whole-room or whole-enclosed space air purification. The position of first air inlet 30 with regard to housing 12 is usually fixed and not adjustable like duct inlet 42. The operation of apparatus 10 and the function of each inlet is explained in further detail below.

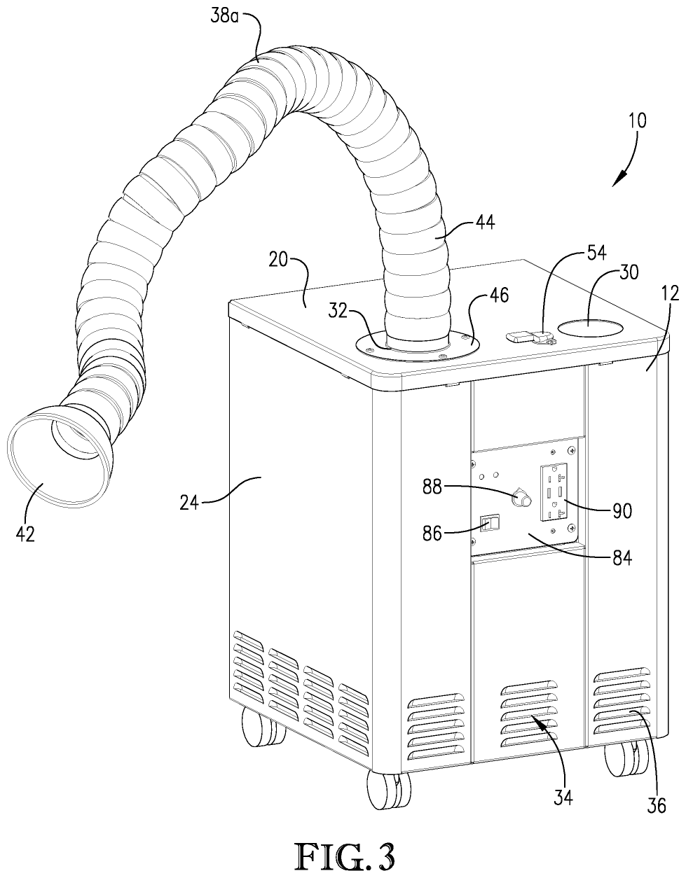

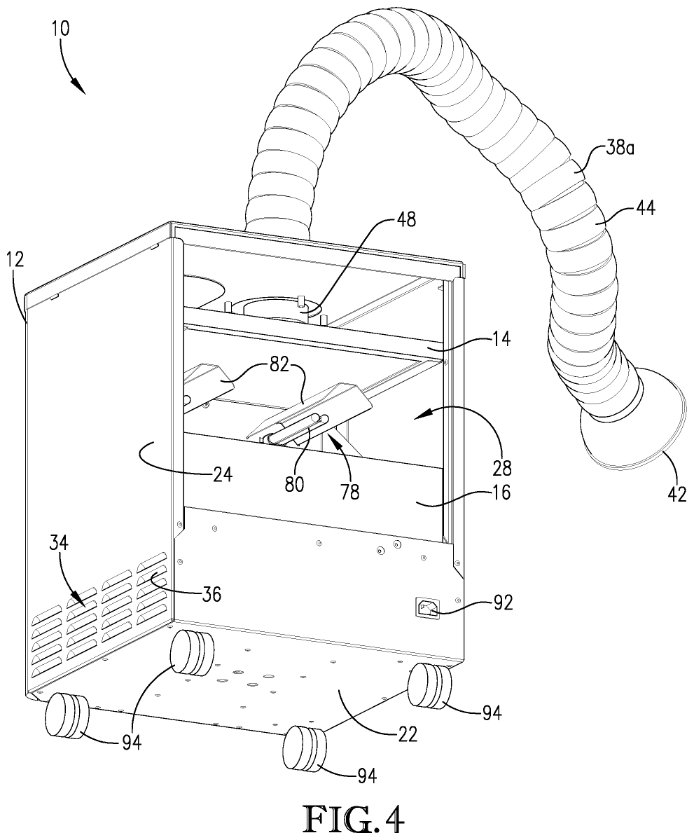

FIGS. 3 and 4 illustrate another embodiment of elongate duct 38a. Duct 38a comprises a plurality of corrugated segments 44 which renders the duct flexible along the majority of its length. The corrugated segments 44 permit the duct 38a to assume almost any configuration so that duct inlet 42 can be placed and maintained in the desired location within the enclosed space. Regardless of the configuration of the duct, the elongate duct 38 may be secured to the second air inlet 32 by a flange 46 that is attached to top wall 20, and may also comprise an outlet section 48 that extends into the interior space 28.

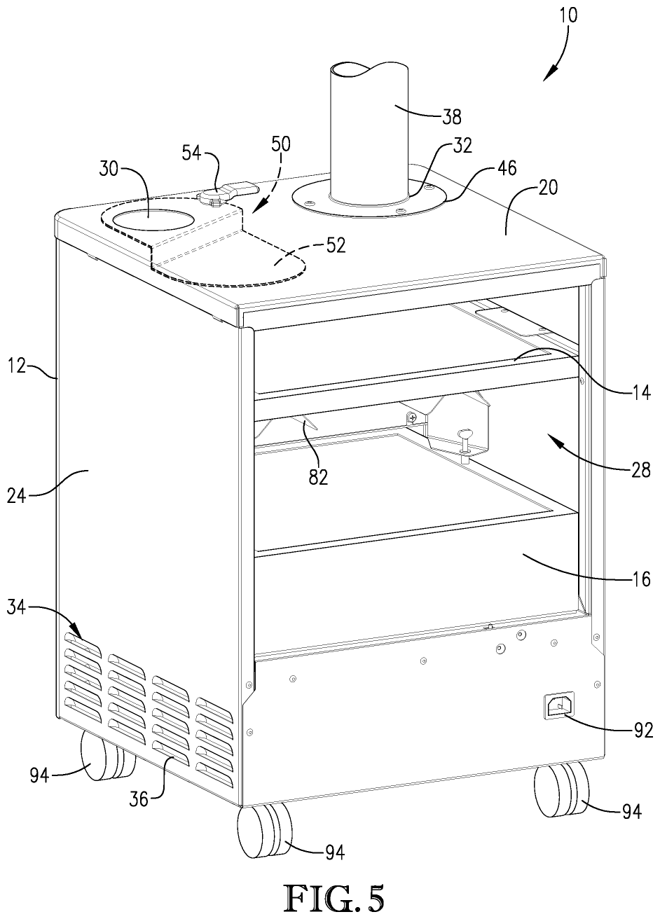

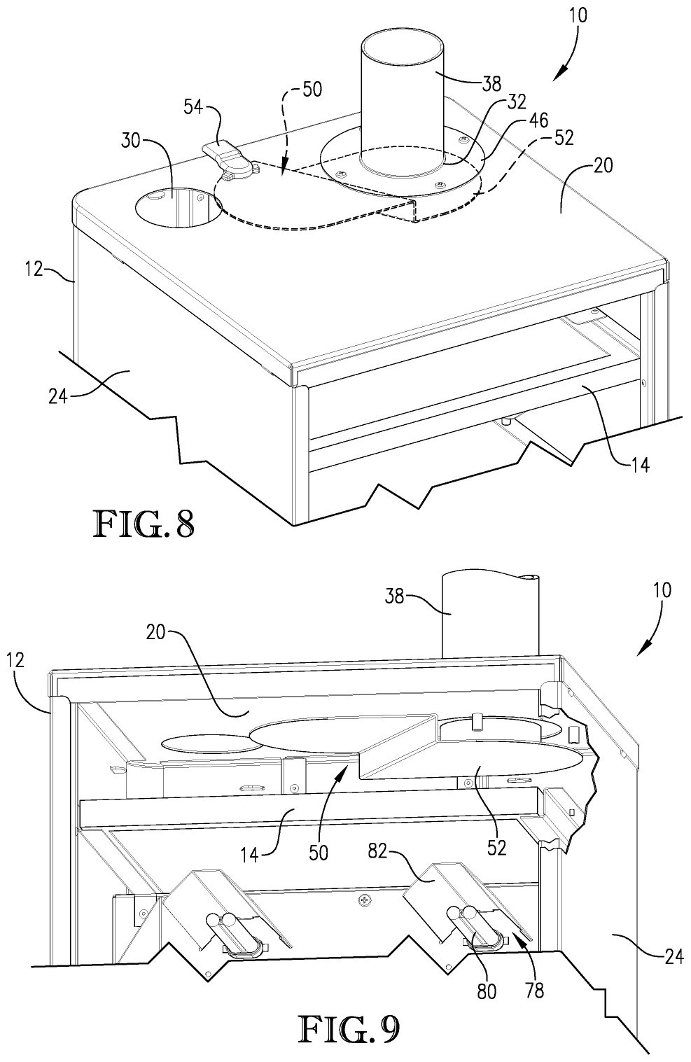

As shown in FIGS. 5 and 7-9, apparatus 10 may comprise an air flow diverter assembly 50 that is configured to be switchable between a first configuration in which the first flow path is blocked and the second flow path is opened, and a second configuration in which the second flow path is blocked and the first flow path is opened. As illustrated, the air flow diverter assembly 50 comprises a shiftable gate member 52 attached to a control lever 54. However, other configurations and structures can comprise assembly 50, including electronically or mechanically controlled sliding louvers or plates, interchangeable housing top walls, caps for inlets 30, 32, or any other suitable means for selectively blocking and unblocking the first and second air inlets 30, 32 thereby preventing or permitting air from being drawn therethrough. In one exemplary embodiment, the assembly 50 may comprise a top that drops in and covers at least one of the air inlets 30, 32. It is noted that such may require that the elongate duct 38 be detached from top wall 20 first. While in certain embodiments it may be preferred for air to be drawn into housing 12 through only one air inlet at a time, it is within the scope of the present invention for air to be drawn into housing 12 through both the first and second air inlets 30, 32 simultaneously. Thus, the air flow diverter assembly 50 may also be configured to be switchable to a third configuration in which both the first and second flow paths are open simultaneously.

In one embodiment of the present invention, and as depicted in FIGS. 4 and 5, for example, the filter media comprises a first filter section or cartridge 14 that comprises an adsorbent, absorbent, and/or other neutralizing material. In preferred embodiments, the adsorbent or absorbent material comprises metal oxide or metal hydroxide nanocrystalline particles capable of removing one or more undesirable substances from the flow of air. The nanocrystalline materials may comprise, consist of, or consist essentially of nanocrystalline metal oxides and hydroxides, coated metal oxides/hydroxides (i.e., halogen coatings), doped metal oxides/hydroxides, surfactant coated nanocrystalline metal oxides and combinations thereof. The terms “metal oxides” and “metal hydroxides” as used herein collectively refer to all such materials that comprise, preferably as the principal constituent, a metal oxide or metal hydroxide material. Preferred nanocrystalline materials for use in connection with the present invention include the metal oxides and metal hydroxides of Mg, Sr, Ba, Ca, Ti, Zr, Fe, V, Mn, Ni, Cu, Al, Si, Zn, Ag, Mo, Sb, Cr, Co and mixtures thereof. Additional preferred nanocrystalline materials include coated nanocrystalline materials such as those disclosed in U.S. Pat. Nos. 6,093,236, and 5,759,939 (metal oxide coated with another metal oxide), halogenated particles such as those disclosed in U.S. Pat. Nos. 6,653,519, 6,087,294 and 6,057,488 (nanocrystalline materials having reactive atoms stabilized on the surfaces thereof, the reactive atoms including oxygen ion moieties, ozone, halogens, and group I metals), doped metal oxides and hydroxides such as silver doped alumina, intimately mixed metal oxides such as combinations of Mg, Al, and Ti, carbon coated metal oxides, and air stable nanocrystalline materials such as those described in U.S. Pat. Nos. 6,887,302 and 6,860,924 (nanocrystalline materials coated with a surfactant, wax, oil, silyl, synthetic or natural polymer, or resin), all of which are incorporated by reference herein. The nanocrystalline materials preferably present crystallite sizes of less than about 25 nm, more preferably less than 20 nm, and most preferably less than 10 nm. The nanocrystalline particles preferably exhibit a Brunauer-Emmett-Teller (BET) multipoint surface area of at least about 15 m²/g, more preferably at least about 70 m²/g, and most preferably from about 100-850 m²/g. It is noted that the nanocrystalline materials need not comprise single crystals, and hence have particle sizes that correspond with the indicated crystallite sizes. Rather, the nanocrystalline materials may comprise aggregates of pluralities of crystallites and have actual particle sizes (as measured across the largest dimension of the particle) that are larger, such as on the order of about 0.5 microns to about 5 mm, about 1 micron to about 2.5 mm, or about 10 microns to about 1 mm.

Generally, filter cartridge 14 comprises a first filter material that contains the adsorbent or absorbent materials, and optionally, a second filter material that is capable of removing particulate matter from the air flowing through apparatus 10. The second filter material can be inter-dispersed with the first filter material or can be located entirely upstream or downstream therefrom. In certain embodiments, it is desirable to locate the second filter material upstream from the first filter material so that particulate matter dispersed within the air can be removed prior to coming into contact with the first filter material containing the nanocrystalline particles, so as to avoid clogging or blocking air flow to the particles.

The first filter material may comprise a porous woven or non-woven material in which the nanocrystalline particles are entrapped. The woven or non-woven material may comprise a synthetic resin foam or film containing the nanocrystalline particles. Exemplary woven or non-woven materials include natural fibers (e.g., cellulose, cotton, wool, etc.) and synthetic fibers (e.g., acrylic aromatic polyaramide, polyethylene, polypropylene, polyester, polyimide, glass, polyphenylene sulfide, bi-component fibers, etc.). The second filter material may comprise the same or similar material as used in the first filter material. The second filter material may also contain nanocrystalline particles or it may not. Exemplary materials for use as the second filter material include natural fibers (e.g., cellulose, cotton, wool, etc.) and synthetic fibers (e.g., acrylic aromatic polyaramide, polyethylene, polypropylene, polyester, polyimide, glass, polyphenylene sulfide, bi-component fibers, etc.).

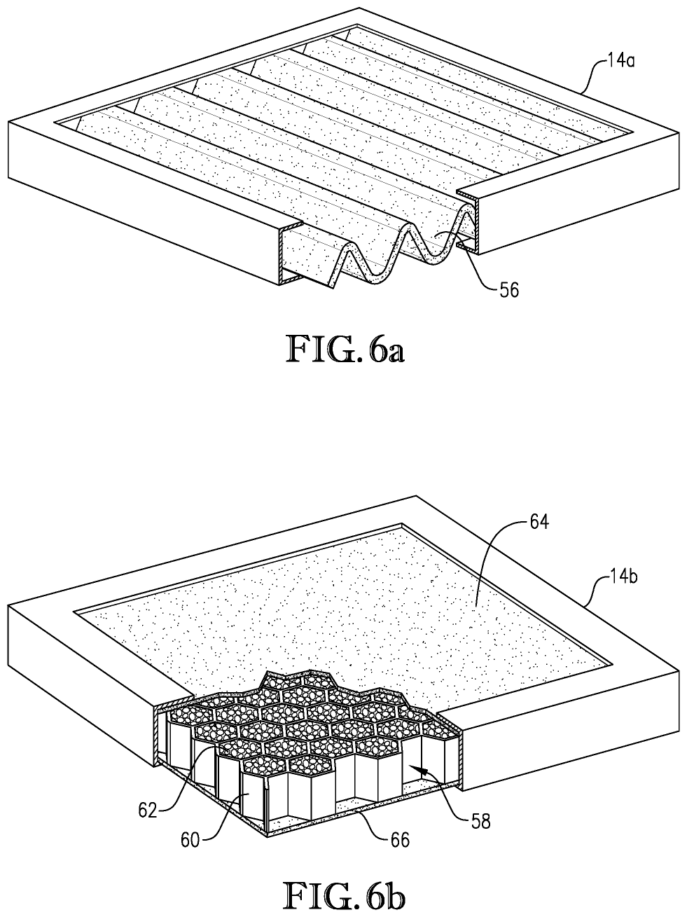

FIGS. 6a and 6b illustrate exemplary filter cartridges that may comprise the nanocrystalline particles. Turning first to FIG. 6a, cartridge 14a comprises a pleated sheet 56 of non-woven material into which the nanocrystalline particles are substantially uniformly distributed. Preferably, the nanocrystalline particles are entrapped evenly throughout the non-woven material thereby maximizing the available surface area to come into contact with the air flow and also to avoid problems associated with uneven settling of particles post-manufacture of the cartridge 14a. The ability to keep the nanocrystalline particles evenly distributed throughout the filter media indicates that the nanocrystalline particles are not simply applied as a loose powder to the filter. Rather, the particles and first filter material are formed in such a manner that the particles are entrapped and maintain a relatively constant local position within the filter material. In other embodiments, the first filter material comprises granules upon which the nanocrystalline particles are deposited as a coating. The granules may be nanocrystalline metal oxide/hydroxide particles themselves or may be another type of inert porous substrate such as activated carbon. The nanocrystalline particles may be applied to the granules as a plurality of coating layers in order to give a “time-release” odor-absorbance effect wherein subsequent inner layers would gradually gain exposure to the air being circulated through the filter by the air handling apparatus.

FIG. 6b illustrates an alternate embodiment of a filter cartridge made in accordance with the present invention. Cartridge 14b comprises a honeycomb-like structure 58 that includes a plurality of discrete cells 60 with each cell containing a quantity of granular nanocrystalline metal oxide or metal hydroxide material 62. The granules 62 are contained in the cells 60 by first and second sheets 64, 66 of finely porous material. Sheets 64, 66 may comprise woven or non-woven materials that are sufficiently permeable to permit air to freely pass therethrough, but do not permit the granules 62 to escape cells 60. Thus, granules 62 are entrapped within cells 60 and remain substantially uniformly distributed throughout cartridge 14b. Sheets 64, 66 may also be made of material similar to the above-described first and second filter materials and be capable of filtering particulate matter from the air prior to passage through the honeycomb section 58.

In certain embodiments according to the present invention, the nanocrystalline particles are present in the filter cartridge 14 at a loading of between about 50 g to about 1 kg per square foot (about 538 g to about 10.74 kg per square meter).

Other filter media that may be used with the present invention is described in U.S. Pat. No. 8,496,735, which is incorporated by reference herein in its entirety.

In embodiments of the present invention, the filter media may also comprise second filter section or cartridge 16. Filter cartridge 16 is selected based on the target application for apparatus 10. In one or more embodiments, the target application for apparatus 10 requires particulate removal. Therefore, filter cartridge 16 may comprise a high-efficiency particulate air (HEPA) filter section or cartridge. As used herein, a “HEPA” filter is any type of filter that meets the requirements stated in U.S. Department of Energy Standard 3020-2015. Generally, this this type of air filter can theoretically remove at least 99.97% of dust, pollen, mold, bacteria, and any airborne particles with a size of 0.3 microns (μm). In alternate embodiments, the target application for apparatus 10 may be chemical compound removal, rather than particulate matter removal. In such embodiments, a HEPA filter need not be employed. Instead, a filter material capable of adsorbing or absorbing the target chemical compound, such as a filter comprising activated carbon or a packed bed of nanocrystalline metal oxides or metal hydroxides, may be used.

Thus, in one or more embodiments, the filter media is capable of removing particles (i.e., dust, pet hair, lint, etc.) dispersed within the air, but also, due to the presence of the nanocrystalline particles, can remove and neutralize undesirable chemical and biological substances present in the air, such as odors, bacteria, viruses, fungi, and toxins. Common odors that may be removed by the inventive filter cartridges include those caused by a member selected from the group consisting of urine, feces, sweat, decaying biological material, pesticides, organic solvents, volatile organic compounds, and combinations thereof. U.S. Patent Application Publication 2009/0098016, incorporated by reference above, discloses further exemplary odor-causing substances that may be removed by the nanocrystalline particles used with the present filter cartridge. Additionally, the nanocrystalline particles have the ability to remove harmful non-odorous materials and substances from air within the enclosed space. Exemplary materials and substances include HCN, CO, and biological species like viruses, bacteria, toxins, and fungi.

One of skill in the art would recognize that the geometry of the filter cartridges 14, 16 could be altered to suit the required application, such as, for example, a canister-type filter, round filter, etc.

As illustrated in the Figures, in one or more embodiments of the present invention, filter cartridge 14 is located above filter cartridge 16, or, because the air flows within housing in a generally vertical direction from top to bottom, filter cartridge 14 is located upstream from filter cartridge 16. Thus, air entering through either of the first or second air inlets 30, 32 travels vertically downward within housing 12, through filter cartridge 14, and then continues in a vertically downward direction through filter cartridge 16. Once the air has passed through filter cartridge 16, the air flow direction may change so that it is discharged through openings 36. However, in one or more embodiments, it is preferred that the air flow within interior space 28, and particularly in that portion of interior space 28 that is bounded by filter cartridges 14 and 16, the air flows in a vertically downward direction only.

As illustrated in FIG. 7, the bottom margin of interior space 28 can be defined by plate 68. Plate 68 generally comprises a central opening so that air flowing through the housing can pass into blower 18, but blower 18 is preferably positioned beneath and outside of interior space 28. Therefore, the air flow direction within the interior space between the first and second air inlets 30, 32 and the central opening of plate 68 is in a vertically downward direction.

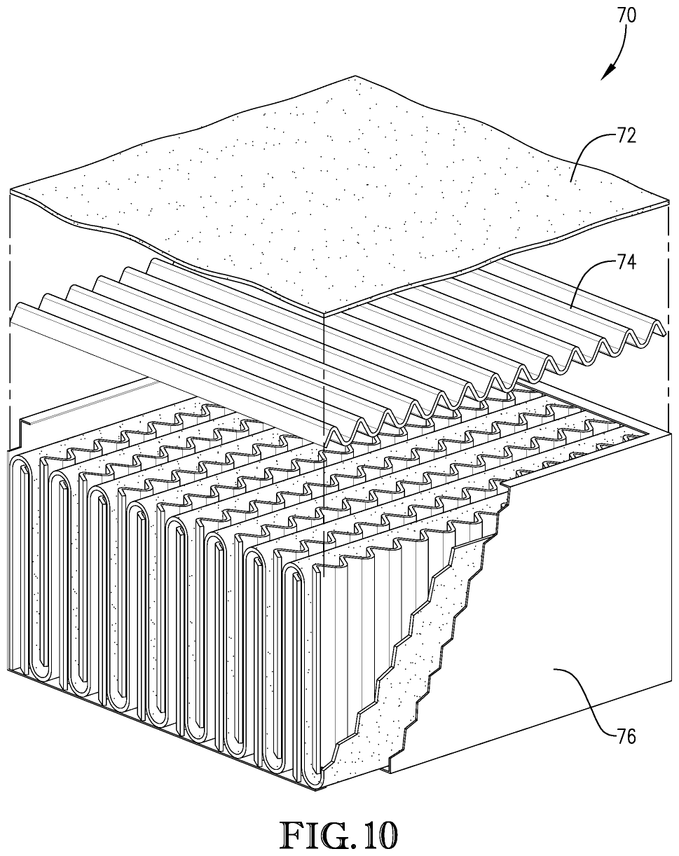

In an alternate embodiment, separate filter cartridges 14, 16 can be replaced by a single filter cartridge 70 as illustrated in FIG. 10. In certain embodiments, this combined filter cartridge can be located similarly within housing 12 as filter cartridge 14, proximate blower 18, although certainly other arrangements may be possible without departing from the scope of the present invention.

Filter cartridge 70 comprises a top sheet 72 of filter material, such as any woven or non-woven filter material described previously herein. Next to that is located a filter layer 74 comprising the nanocrystalline particles, according to any embodiment previously described herein. The pleated filter material of FIG. 6a is shown merely for illustrative purposes. Next to filter layer 74 is a HEPA filter layer 76, also constructed according to any embodiment previously described herein. By placing all of the filter layers 72, 74, 76 in a single filter cartridge 70, the burden on the end user to service and maintain apparatus 10 is significantly reduced. It is noted, that the filter layer 76 need not always comprise a HEPA filter, but as described above, the filter layer can be selected to specifically address the target application for apparatus 10, such as chemical adsorption or absorption.

In one or more embodiments, and as can be seen in FIG. 9, for example, apparatus 10 optionally comprises a UV-light assembly 78 operable to deliver UVC radiation onto the filter media. Generally, UVC radiation is ultraviolet light having a wavelength within the range of 100-280 nm. This short-wave radiation has germicidal characteristics, which makes it well suited for destroying or deactivating harmful biological substances, such as viruses, bacteria, and fungi.

In one or more embodiments, the UV-light assembly comprises a least one UV-light source 80 and at least one shield 82 positioned over the at least one UV-light source 80 and configured to shield the first and second air inlets 30, 32 from exposure to the UVC radiation, namely so that the UVC light produced by light source 80 does not escape housing 12. In certain embodiments, the amount of UVC light that escapes housing 12 is less than 100 μW/cm². The light source 80 can be any device capable of emitting UVC radiation such as shortwave ultraviolet lamps, UVC LEDs, and ultraviolet lasers. Shield 82 is preferably a bent metallic sheet that is positioned immediately above the light source 80, although other materials capable of absorbing or deflecting UVC radiation may also be used.

In one or more embodiments, it is preferable for the UV-light assembly 80 to be operable to deliver UVC radiation onto the HEPA filter. It is contemplated that the bulk of all particulate materials captured by the filter media will be captured and retained within the HEPA filter 16. Therefore, UVC radiation emitted from assembly 80 can be used to prevent, inhibit, or otherwise reduce pathogen levels on the HEPA filter thereby keeping them from being reintroduced into the enclosed space as the air flow exits housing 12 via outlet 34.

In certain embodiments, therefore, filter cartridge 14 is positioned between the air inlets 30, 32 and the at least one shield 82. In this embodiment, little or no UVC radiation is directed onto filter cartridge 14. In certain embodiments, filter cartridge 16 is positioned between the UV-light source 80 and the blower 18.

In embodiments in which the combined filter cartridge 70 is employed, the UV light source 80 directs UVC radiation onto sheet 72 and into filter layer 74. Preferably, filter layer 74 is constructed so that at least a portion the UVC radiation penetrates filter layer 74 to reach HEPA filter layer 76.

A control panel 84 may be provided on the front of housing 12 to provide for a power switch 86, a blower speed control dial 88, and a power port 90. Power port 90 may comprise standard electrical receptacles and/or USB charging ports so that other devices also in use in the space in which apparatus 10 is located can be conveniently plugged in. Also, as can be seen in FIG. 2, a power supply port 92 is provided on the back side of housing 12 to provide power to apparatus 10.

Apparatus 10 may also be provided with a set of casters 94 to permit the apparatus to be readily movable between enclosed spaces or different locations within the same enclosed space. Casters 94 may also have the ability to be locked to prevent apparatus 10 from being moved once in the desired location.

Apparatus 10 can be used in a variety of settings to provide contaminant removal from the air within a space. Apparatus 10 is highly useful in applications in which potentially hazardous aerosols are created, such as dental operatories, operating rooms, laboratories, and certain kinds of manufacturing facilities.

Methods according to one or more embodiments of the present invention comprise inducing an air flow within housing 12 using blower 18 that is installed within the housing. The air flow is then selectively caused to enter housing 12 through either (or both) of first and second air inlets 30, 32 and then exit housing through at least one air outlet 34. The air flow, as it flows through housing 12, is directed along either a first flow path located between the first air inlet 30 and the at least one air outlet 34, or a second flow path located between the second air inlet 32 and the at least one air outlet 34. As the air flows through housing 12, it is caused to pass through filter media 14, 16, which is positioned across both the first and second flow paths. As the air passes through filter media 14, undesirable materials, such as pathogens, solid particles, liquid droplets, and odors, are removed. Thus, the air flow exiting through outlet 34 is of a greater purity than the air drawn in through inlets 30, 32.

The step of selectively causing the air flow to enter the housing 12 comprises shifting the air flow diverter assembly 50 between a first configuration in which the first flow path is blocked and the second flow path is opened, and a second configuration in which the second flow path is blocked and the first flow path is opened. As noted above, assembly 50 may also be configured to permit air to be simultaneously drawn into housing 12 via both inlets 30, 32. In certain embodiments, the air flows vertically through the apparatus 10 between the first and second inlets 30, 32 and the one or more outlets 34. In certain embodiments, blower 18 is capable of drawing at least 100, at least 150, or at least 200 cubic feet per minute of air through apparatus 10. Thus, in the context of a small operatory as one may customarily find in a dental office, the air within the operatory can be circulated through apparatus 10 every minute or two or less.

In embodiments of the present invention in which a UV light assembly 78 is present, the UV-light assembly delivers UVC radiation onto least a portion of the filter media, and preferably onto at least onto HEPA filter 16. In addition, UV light assembly 78 may also be configured to deliver disinfecting UVC radiation onto any exposed internal surfaces of housing 12 onto which particulate matter and pathogens may accumulate during operation of apparatus 10.

Apparatus 10 is operable to both draw in air from the enclosed space generally (i.e., the air located proximate housing 12) and from a specific point within the enclosed space that is remote from the housing 12 through use of the elongate duct 38. When apparatus 10 is operating to draw in air through the second air inlet 32, and hence, through duct inlet 42, the duct inlet 42 is positioned adjacent to the point within the enclosed space. In the context of a dental operatory, the duct inlet 42 can be positioned adjacent the patient's mouth so that aerosols or other materials generated during the dental procedure can be drawn into duct inlet 42 and processed by apparatus 10. When a dental procedure is not taking place that requires point specific air purification, apparatus 10 can be operated such that air is drawn in through first air inlet 30 so as to process and remove impurities that might generally be present within air of the enclosed space.

This methodology translates to other fields such as general medical and surgical procedures in which duct inlet 42 can be positioned adjacent the portion of the patient's body that is undergoing the procedure to draw in aerosols or particles from the patient's body that are generated by the procedure. In the context of laboratory usage, apparatus 10 can be used when working with noxious chemicals or biological agents to remove and sequester odors, fumes, solid particulates, or liquid droplets that may be generated during laboratory work by positioning duct inlet 42 adjacent the work site. When the lab work is completed, diverter assembly 50 can be switched so that air adjacent apparatus 10 is drawn in through first air inlet 30.

Apparatus and methods according to the present invention can also be used in other industrial and service industry settings. For example, apparatus 10 can be used within enclosed spaces in which welding is occurring as duct inlet 42 can be positioned adjacent the welding site to draw in particulate matter and/or gases produced from the welding operation. Apparatus 10 can also be used in personal services settings such as nail salons, beauty salons, and spas to remove volatilized organic compounds and other chemicals, or other noxious odors or fumes that may be produced in the rendering of certain services. In addition, apparatus 10 can be used in kitchens and restaurants to eliminate odors produced during food preparation.

Note, these examples are provided by way of illustration, and there are many other applications that are contemplated by the present invention. Thus, these examples should not be viewed as limiting upon the scope of the present invention in any way.

We claim:

1. A filter cartridge for an air purifying apparatus comprising a filter frame inside of which is located a filter media, the filter media comprising:
a first filter section comprising a polymer fiber mat material capable of capturing particulates suspended in the air;
a second filter section comprising a plurality of discrete cells, each cell containing a quantity of granular nanocrystalline metal oxide or metal hydroxide material; and
a third filter section comprising a high efficiency particulate air (HEPA) filter material.

2. The filter cartridge of claim 1, wherein the second filter section comprises a porous material, wherein the porous material covers a first and a second open face of each cell to entrap the quantity of granular nanocrystalline metal oxide or metal hydroxide material therein.

3. The filter cartridge of claim 2, wherein the nanocrystalline metal oxide or metal hydroxide granules remain substantially uniformly distributed throughout the second filter section.

4. The filter cartridge of claim 3, wherein the quantity of granular nanocrystalline metal oxide or metal hydroxide material is present in the second filter section at a loading of between about 50 g to about 1 kg per square foot.

5. The filter cartridge of claim 2, wherein the porous material comprises woven or non-woven material.

6. The filter cartridge of claim 5, wherein the non-woven or woven material comprises natural or synthetic fibers.

7. The filter cartridge of claim 1, wherein the filter media is capable of removing at least 99.97% of any airborne particles having a size of 0.3 microns and at least 99% of undesirable chemical or biological substances present in the air.

8. The filter cartridge of claim 1, wherein each cell is configured in a hexagon shape.

9. The filter cartridge of claim 1, wherein the third filter section is thicker than the second filter section.

10. The filter cartridge of claim 1, the filter cartridge having a first and second face,
wherein the first filter section is adjacent to the first face of the filter cartridge, the third filter section is adjacent to the second face of the filter cartridge, and the second filter section is juxtaposed between the first filter section and the third filter section; and
the filter cartridge being configured to have a flow of air enter the first face and leave through the second face.

11. The filter cartridge of claim 10, wherein the first face of the filter cartridge is positioned near a UV-light source, the UV-light source directing UVC radiation into the filter cartridge so as to penetrate the first filter section and reach the second filter section and, optionally, the third filter section.

12. Air purifying apparatus comprising:
a housing having at least first and second air inlets and at least one air outlet;
a blower operable to induce a flow of air within the housing, the flow of air being selectively directed along either a first flow path located between the first air inlet and the at least one air outlet or a second flow path located between the second air inlet and the at least one air outlet; and
filter media contained within the housing and positioned across the flow paths, such that the flow of air within the housing passes through the filter media,
the filter media comprising an adsorbent, absorbent, and/or neutralizing material capable of removing one or more undesirable substances from the flow of air.

13. The air purifying apparatus of claim 12, wherein the housing has top wall, bottom wall, and sidewall structure; the first and second air inlets being located in the housing top wall, and the at least one outlet being located within the sidewall structure.

14. The air purifying apparatus of claim 12, wherein the apparatus further comprises a UV-light assembly operable to deliver UVC radiation onto the filter media and/or one or more internal surfaces of the housing.

15. The air purifying apparatus of claim 14, wherein the UV-light assembly comprises a least one UV-light source and at least one shield positioned over the at least one UV-light source and configured to shield the first and second air inlets from exposure to the UVC radiation.

16. The air purifying apparatus of claim 12, wherein the filter media comprises a first filter section that includes the metal oxide or metal hydroxide nanocrystalline particles, and a second filter section that includes a high efficiency particulate air (HEPA) filter.

17. The air purifying apparatus of claim 12, wherein the apparatus is configured so that the air flows vertically through the apparatus between the first and second inlets and the one or more outlets.

18. The air purifying apparatus of claim 12, wherein the apparatus further comprising an air flow diverter assembly that is configured to be switchable between a first configuration in which the first flow path is blocked and the second flow path is opened, and a second configuration in which the second flow path is blocked and the first flow path is opened.

19. The air purifying apparatus of claim 18, wherein the air flow diverter assembly is configured to be switchable to a third configuration in which both the first and second flow paths are open simultaneously.

20. The air purifying apparatus of claim 12, wherein the first air inlet is configured to generally draw air into the housing from an enclosed space in which the apparatus is located.

21. The air purifying apparatus of claim 20, wherein the second air inlet is coupled with an elongate duct having a duct inlet and a duct outlet, the duct inlet being configured to be selectively positioned adjacent a localized region within the enclosed space and draw air into the duct from the localized region, the duct outlet being connected to the second air inlet.

22. The air purifying apparatus of claim 12, wherein the adsorbent or absorbent material comprises metal oxide or metal hydroxide nanocrystalline particles.

23. Air purifying apparatus comprising:
a housing having a first and second air inlets and at least one air outlet,
the first air inlet configured to generally draw air into the housing from an enclosed space in which the apparatus is located,
the second air inlet coupled with an elongate duct having a duct inlet and a duct outlet, the duct inlet being configured to be selectively positioned adjacent a localized region within the enclosed space and draw air into the duct from the localized region, the duct outlet being connected to the second air inlet;
a blower operable to induce a flow of air within the housing between either a first flow path located between the first air inlet and the at least one air outlet or a second flow path located between the second air inlet and the at least one air outlet;
an air flow diverter assembly configured to be switchable between a first configuration in which the first flow path is blocked and the second flow path is opened, and a second configuration in which the second flow path is blocked and the first flow path is opened; and
filter media contained within the housing and positioned between the first and second air inlets and the at least one air outlet such that air flowing through either the first or second flow path passes through the filter media,
the filter media comprising a first filter section that includes metal oxide or metal hydroxide nanocrystalline particles capable of removing one or more undesirable substances from the flow of air, and a second filter section that includes a high efficiency particulate air (HEPA) filter.

24. The air purifying apparatus of claim 23, wherein the housing has top wall, bottom wall and sidewall structure, the first and second air inlets being located in the housing top wall, and the at least one outlet being located within the sidewall structure.

25. The air purifying apparatus of claim 23, wherein the apparatus further comprises a UV-light assembly operable to deliver UVC radiation onto the filter media and/or one or more internal surfaces of the housing.

26. The air purifying apparatus of claim 25, wherein the UV-light assembly is operable to deliver UVC radiation onto the HEPA filter.

27. The air purifying apparatus of claim 25, wherein the UV-light assembly comprises a least one UV-light source and at least one shield positioned over the at least one UV-light source and configured to shield the first and second air inlets from exposure to the UVC radiation.

28. The air purifying apparatus of claim 27, wherein the first filter section is positioned between the air inlets and the at least one shield.

29. The air purifying apparatus of claim 27, wherein the second filter section is positioned between the UV-light source and the blower.

30. The air purifying apparatus of claim 23, wherein the apparatus is configured so that the air flows vertically through the apparatus between the first and second inlets and the one or more outlets.

31. The air purifying apparatus of claim 23, wherein the air flow diverter assembly is configured to be switchable to a third configuration in which both the first and second flow paths are open simultaneously.

32. A method of removing contaminants from air comprising:
inducing a flow of air within a housing of an air purification apparatus using a blower installed within the housing;
selectively causing the flow of air to enter the housing through either of at least a first or second air inlet and exit the housing through at least one air outlet, the flow of air, as it flows through the housing, being directed along either a first flow path located between the first air inlet and the at least one air outlet or a second flow path located between the second air inlet and the at least one air outlet;
causing the flow of air to pass through filter media contained within the housing and positioned across the first and second flow paths, the filter media comprising an adsorbent, absorbent, and/or neutralizing material capable of removing one or more undesirable substances from the flow of air.

33. The method of claim 32, wherein the step of selectively causing the flow of air to enter the housing comprises shifting an air flow diverter assembly between a first configuration in which the first flow path is blocked and the second flow path is opened, and a second configuration in which the second flow path is blocked and the first flow path is opened.

34. The method of claim 32, wherein the air purification apparatus further comprises a UV-light assembly, and wherein the UV-light assembly delivers UVC radiation onto the filter media and/or one or more internal surfaces of the housing.

35. The method of claim 32, wherein the air flows vertically through the apparatus between the at least first and second inlets and the one or more outlets, wherein the at least first and second inlets are located in a housing top wall, and the at least one outlet is located within a housing sidewall structure.

36. The method of claim 32, wherein the second air inlet is coupled with an elongate duct having a duct inlet and a duct outlet, wherein the duct inlet is selectively positioned adjacent a localized region within an enclosed space in which the apparatus is located and draws air into the duct from the localized region, the duct outlet being connected to the second air inlet.

37. The method of claim 32, wherein the first air inlet generally draws air into the housing from an enclosed space in which the apparatus is located.

38. The method of claim 32, wherein the adsorbent or absorbent material comprises metal oxide or metal hydroxide nanocrystalline particles.
